(19) United States
(12) Patent Application Publication
(10) Pub. No.: US 2007/0086044 A1
(43) Pub. Date: Apr. 19, 2007

(54) Image forming apparatus device having fax function and method for receiving fax data thereof

(75) Inventor: Jin-su Yun, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/439,202

(22) Filed: May 24, 2006

(30) Foreign Application Priority Data
Oct. 18, 2005 (KR) 2005-0098303

(51) Int. Cl. G06F 3/12

(52) U.S. Cl. 358/1.15; 358/401

(57) ABSTRACT

An image forming device having a fax function and a method for receiving fax data thereof are provided, in which a printing hue mode determining unit determines a preset printing hue mode, a developing agent determining unit determines usability of a developing agent corresponding to the determined printing hue mode, a public switched telephone network (PSTN) interfacing unit performs interface with a transmitter through the PSTN, a controlling unit controls the transmitter to be requested to transmit a fax data in a predetermined mode through the PSTN interfacing unit, and a printing unit prints the fax data received through the PSTN interfacing unit. Accordingly, a user can transmit and receive the fax data in the preset mode and received fax data according to a printing option set or a reception state of the image forming apparatus.

### CROSS-REFERENCE TO RELATED APPLICATIONS

This application claims the benefit under 35 U.S.C. § 119(a) of Korean Patent Application No. 2005-98303, filed Oct. 18, 2005, in the Korean Intellectual Property Office, the entire disclosure of which is hereby incorporated by reference.

### BACKGROUND OF THE INVENTION

1. Field of the Invention

The present invention relates to an image forming device having a facsimile or fax function and a method for receiving fax data thereof. More particularly, the present invention relates to an image forming device having a fax function and a method for receiving fax data thereof in a format according to a printing option set or a printing state of the image forming apparatus receiving fax data.

2. Description of the Related Art

A facsimile or fax is a device that converts a static image into an electric signal and transmits the converted static image through a communication channel. Data transmitted from a transmitter's facsimile is received through a recipient's facsimile and provided to a user.

Because the facsimile converts the static image into the electric signal, the transmitter recognizes the static image in black and white, regardless of hues of the static image to be transmitted (black and white, or other colors). Accordingly, the recipient provides the user with a document of the static image in black and white.

With recent digital technological developments, a newly developed multi function printer (MFP) having conventional individual devices, such as a printer, duplicator and facsimile, are integrated into one device. The use of the MFP is increasing, since the developed MFP enables the recipient to receive fax data in color, by use of a color-printing function, if the transmitter transmits the fax data in color using the facsimile-enabled MFP.

In a system that transmits and receives fax data in color, before transmitting the fax data, a transmitter's MFP determines a state of a recipient's MFP through communication with the recipient's MFP.

The transmitter's MFP transmits fax data in color when the recipient's MFP can process the fax data in color, and transmits fax data in black and white when the recipient's MFP can not process the fax data in color.

However, a problem exists when the recipient's MFP processes the fax data in color and cannot perform a printing operation of the received fax data. Accordingly, the transmitter's MFP cannot determine the problematic state of the recipient's MFP and transmits the existing fax data in color.

Also, the recipient's MFP may wish to receive the fax data in black and white, although the transmitter's MFP transmits the fax data in color. In a conventional system, it is impossible for the recipient's MFP to select a format of fax data transmitted from the transmitter's MFP.

Accordingly, there is a need for an improved image forming apparatus having a fax function and a method for receiving fax data that transmits and receives fax data in a preset mode, and receives fax data according to a set printing option.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an image forming device having fax function and a method for receiving fax data thereof, which selectively receives fax data in a mono mode or a color mode in accordance with a usable developing agent at a recipient's image forming apparatus and a printing hue mode set by a user.

In order to achieve the above-described aspects of exemplary embodiments of the present invention, there is provided an image forming apparatus having fax function, in which, a printing hue mode determining unit determines a preset printing hue mode; a developing agent determining unit determines usability of a developing agent corresponding to the determined printing hue mode; a public switched telephone network (PSTN) interfacing unit performs interface with a transmitter through a PSTN; a controlling unit controls the transmitter to transmit requested fax data in a predetermined mode through the PSTN interfacing unit; and a printing unit prints the fax data received through the PSTN interfacing unit.

In an exemplary implementation, the developing agent determining unit determines whether the developing agent is in a usable state, if the developing agents of all hues are usable when the determined printing hue mode is in a color mode, and determines whether the developing agent is in a usable state, if at least one of the developing agents of all the hues is usable when the determined printing hue mode is a mono mode.

In an exemplary implementation, the controlling unit controls the PSTN interfacing unit to request the fax data from the transmitter corresponding to the printing hue mode when the developing agent is in the usable state, and request the fax data from the transmitter in a mono mode when the developing agent is unusable.

In an exemplary implementation, the controlling unit requests the fax data in the color mode when the printing hue mode is in the color mode, and requests the fax data in the mono mode when the printing hue mode is the mono mode.

In an exemplary implementation, the printing unit uses a black developing agent to print the fax data when the fax data received through the PSTN interfacing unit is in the mono mode.

In an exemplary implementation, the printing unit uses at least one of the developing agents of all the hues to print the fax data when the fax data received though the PSTN interfacing unit is in the mono mode.

In an exemplary implementation, the printing unit mixes the developing agents of all the hues to print the fax data when the fax data received through the PSTN interfacing unit is in the mono mode.

According to an exemplary embodiment of the present invention, the method for receiving fax data of an image forming device having fax function includes a preset printing hue mode is determined when a communication request is received from a transmitter; usability of a developing agent is determined, which corresponds to the determined printing hue mode; fax data is requested from the transmitter in a predetermined mode according to availability of the determined developing agent; the fax data is received from the transmitter in the predetermined mode; and the received fax data is printed.

In an exemplary implementation, a determination is made as to whether the developing agent is in a usable state, if the developing agents of all hues are usable when the determined printing hue mode is a color mode, and a determination is made as to whether the developing agent is in a usable state, if one of the developing agents of all the hues is usable when the determined printing hue mode is a mono mode.

In an exemplary implementation, the fax data corresponding to the printing hue mode is requested from the transmitter when the developing agent is in the usable state, and the fax data in a mono mode is requested from the transmitter when the developing agent is unusable.

In an exemplary implementation, the fax data in the color mode is requested when the printing hue mode is the color mode, and the fax data in the mono mode is requested when the printing hue mode is the mono mode.

In an exemplary implementation, a black developing agent is used to print the fax data when the received fax data is in the mono mode.

In an exemplary implementation, one of the developing agents of all the hues is used to print the fax data when the received fax data is in the mono mode.

In an exemplary implementation, the developing agents of all the hues are mixed to print the fax data when the received fax data is in the mono mode.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWING FIGURES

The above and other objects, features, and advantages of certain exemplary embodiments of the present invention will be more apparent from the following description taken in conjunction with the accompanying drawing, in which:

FIG. 1 is a block diagram of an image forming apparatus having a fax function according to an exemplary embodiment of the present invention; and

FIG. 2 is a flowchart of a method for receiving fax data of the image forming device having the fax function according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

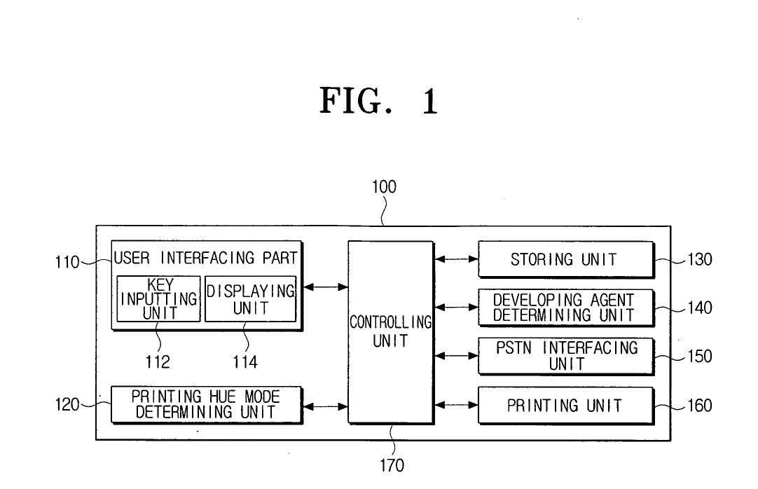

FIG. 1 is a block diagram of an image forming apparatus having a fax function according to an exemplary embodiment of the present invention.

Referring to FIG. 1, according to an exemplary embodiment of the present invention, an image forming apparatus 100 having a fax function includes a user interfacing unit 110, printing hue mode determining unit 120, storing unit 130, developing agent determining unit 140, public switched telephone network (PSTN) interfacing unit 150, printing unit 160 and controlling unit 170.

The user interfacing unit 110 supports interface between the image forming apparatus 100 and a user, and includes a key inputting unit 112 inputting a predetermined requesting signal from the user and a displaying unit 114 displaying predetermined information to provide to the user 114.

The key inputting unit 112 includes a plurality of function keys disposed on a front panel of the image forming apparatus 100. The user may use function keys provided on the key inputting unit 112, for example, a menu key, direction key, selection key, cancellation key and reset key, to select and set several functions offered by the image forming apparatus 100.

The user may use the function keys provided on the key inputting unit 112, for example, the menu key, direction key, and selection key, and move a menu step by step, to select a printing hue mode to be applied, such as, a color mode or a mono mode.

The color mode prints fax data in an original color of the fax data, and the mono mode prints the fax data in one color.

The mono mode may be generally used in a black color, but also applied with one of other colors. For example, if M(Magenta) is the least frequently used color of development agents of each colors including Y(Yellow), M(Magenta), C(Cyan) and K(Black), then the most remaining amount of color is M(Magenta). Therefore, printing the fax data in the M color is desirable for efficient use of the developing agent.

The key inputting unit 112 may be provided with a hot key for selecting the printing hue mode. Therefore, selecting the printing hue mode through the hot key is possible.

The displaying unit 114 is disposed on the front panel of the image forming apparatus 100, similarly to the key inputting unit, and displays predetermined information to be provided to the user by the image forming apparatus 100, under control of the controlling unit 170.

According to an exemplary embodiment of the present invention, the displaying unit 114 may display the printing hue mode preset by the user's setting, and usability of the development agent determined by the developing agent determining unit 140. The displaying unit 114 may display a message informing the user of reception of the fax data, when the fax data is received by the PSTN interfacing unit 150.

The printing hue mode determining unit 120 determines the preset printing hue mode, when a communication request is received from a transmitter. That is, the printing hue mode determining unit 120 determines whether the preset printing hue mode through the key inputting unit 112 by the user is the color mode or the mono mode.

The storing unit 130 includes a non-volatile memory storing various control programs required for implementing a function of the general image forming apparatus 100, and a volatile memory temporarily storing data generated during a program execution of the controlling unit 170.

The storing unit stores information regarding a consumable, such as a developing agent cartridge. The consumable-related information may be stored in an individually mounted memory on the consumable, but may be also stored in the storing unit 130, such as a main memory of the image forming apparatus 100, to be used by the controlling unit 170 to control overall functions of the image forming apparatus 100.

The developing agent determining unit 140 determines usability of the developing agent corresponding to the printing hue mode determined by the determining unit 120. The developing agent determining unit 140 may determine the usability of the developing agents of various colors according to the consumable-related information stored in the storing unit 130, that is, the remaining life span of the developing agent.

The developing agent determining unit 140 determines whether the developing agent is usable when the developing agents of various colors, that is, four colors including Y, M, C, and K, are usable, if the printing hue mode determined by the printing hue mode determining unit 120 is the color mode.

The developing j determining unit 140 determines whether the developing agent is usable when at least one of the developing agents of various colors is usable, if the printing hue mode determined by the printing hue mode determining unit 120 is the mono mode.

The PSTN interfacing unit 150 performs interface between the transmitter and the image forming apparatus 100 through the PSTN. The transmitter requests communication to the image forming apparatus 100 through the PSTN, and the image forming apparatus 100 transmits through the PSTN to the transmitter a current state, such as, a mode of receivable fax data. The transmitter transmits through the PSTN to the image forming apparatus 100 the mode of fax data receivable at the image forming apparatus 100.

The printing unit 160 performs a printing operation of the general image forming apparatus 100. According to an exemplary embodiment of the present invention, the printing unit 160 prints the fax data received through the PSTN interfacing unit 150 from the transmitter, according to the mode of the fax data under control of the controlling unit 170.

That is, the printing unit 160 prints the fax data by using a black developing agent when the fax data is in the mono mode. If the black development agent is not usable, one of the other development agents, excluding the black development agent, may be used or available developing agents of colors may be mixed to use for printing. Also, when the fax data is in the color mode, the printing unit 160 uses the development agent of the color corresponding to the fax data for printing.

The controlling unit 170 controls overall functions of the image forming apparatus 100, and controls signal input and output between the user interfacing unit 110, printing hue mode determining unit 120, storing unit 130, development agent determining unit 140, PSTN interfacing unit 150 and printing unit 160.

The controlling unit 170 requests through the PSTN interfacing unit 150 the receivable fax data from the transmitter in a predetermined mode, such as, the mono mode or the color mode, according to a result determined by the developing agent determining unit 140.

For example, the controlling unit 170 requests to transmit the fax data from the transmitter corresponding to the printing hue mode determined by the printing hue mode determining unit 120, when the developing agent is determined to be usable by the developing agent determining unit 140. That is, the controlling unit 170 requests the fax data corresponding to the printing hue mode preset by the user, since printing the fax data both in the mono mode and the color mode is possible, when the developing agents of various colors are usable. The controlling unit 170 requests to transmit the fax data from the transmitter in the color mode when the printing hue mode is the color mode, and requests the transmitter to transmit the fax data in the mono mode when the printing hue mode is the mono mode.

The controlling unit 170 requests to transmit the fax data from the transmitter in the mono mode, regardless of the printing hue mode determined by the printing hue mode determining unit 120, when a determination is made that the development agent is not usable by the developing agent determining unit 140.

The controlling unit 170 controls the printing unit 160 to use the black developing agent in printing, when the fax data received through the PSTN interfacing unit 150 is the mono mode. If the black developing agent is not available, the controlling unit 170 may control the printing unit 160 to use another developing agent which is a non-black developing agent. Also, the controlling unit 170 may control the printing unit 160 to mix other developing agents, excluding the black developing agent, to be used for printing.

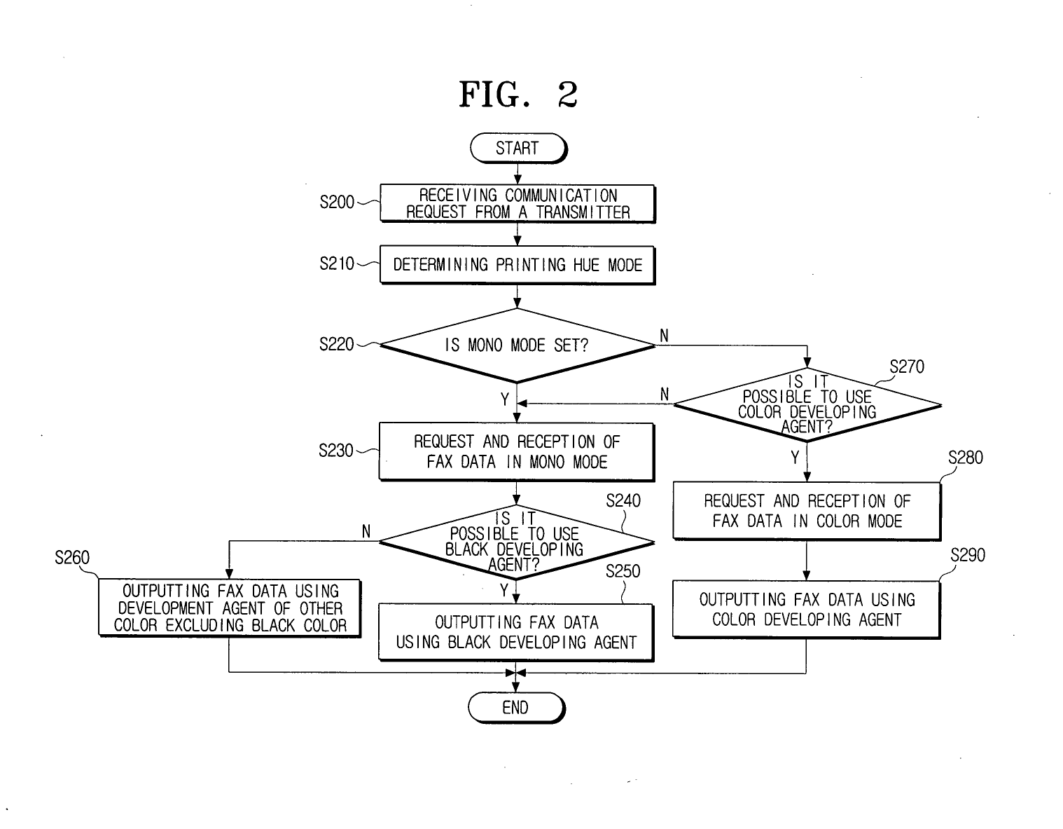

FIG. 2 is a flowchart of a method for receiving fax data of the image forming device having a fax function.

A method for receiving fax data of an image forming device having a fax function will be described in detail with reference to FIGS. 1 through 2.

When the transmitter requests communication through the PSTN, the image forming apparatus 100 receives a communication request from the transmitter through the PSTN interfacing unit 150 supporting interface with the PSTN (S200).

When the communication request is received from the transmitter through the PSTN interfacing unit 150, the printing hue mode determining unit 120 determines whether the preset printing hue mode is the mono mode or the color mode (S210).

When the mono mode is preset by the printing hue mode determining unit, the controlling unit 170 requests the fax data in the mono mode through the PSTN interfacing unit 150. The transmitter transmits the fax data in the mono mode through the PSTN, and the image forming apparatus 100 receives the fax data in the mono mode transmitted from the transmitter through the PSTN interfacing unit 150 (S230).

The fax data in the mono mode is received through the PSTN interfacing unit 150, and the developing agent determining unit 140 determines whether the black developing agent is usable, in order to print the fax data in the mono mode (S240).

In the operation of S240, if the developing agent determining unit 140 determines that the black developing agent is usable, the controlling unit 170 controls the fax data in the mono mode received from the transmitter to be printed using the black developing agent. The printing unit uses the black developing agent to print the fax data in the mono mode (S250).

In the operation of S240, if the developing agent determining unit 140 determines that the black developing agent is not usable, the controlling unit 170 controls the fax data in the mono mode to be printed using another developing agent, which is a non-black developing agent. The controlling unit may control the printing unit 160 to use one of the non-black developing agents for printing, or mix non-black developing agents. The printing unit 160 uses the developing agent to print the fax data in the mono mode under control of the controlling unit 170 (S260).

In the operation of S220, if the printing hue mode determining unit 120 determines that the mono mode is not set, that is, that a color mode is set, the developing agent determining unit 140 determines whether the developing agent of color is usable under control of the controlling unit 170 (S270).

In the operation of S270, if it is determined that the development agent of color is usable, the controlling unit 170 requests the fax data in the color mode through the PSTN interfacing unit 150. The transmitter transmits the fax data in color mode through the PSTN, and the image forming apparatus 100 receives through the PSTN interfacing unit 150 the fax data in the color mode transmitted from the transmitter (S280).

The fax data in the color mode is received and the controlling unit 170 controls the printing unit 160 to print the fax data in the color mode by using the developing agent of color. The printing unit 160 prints the fax data in the color mode by using the developing agent of color under control of the controlling unit 170 (S290).

In the operation of S270, if it is determined that the developing agent of color can not be used by the developing agent determining unit 140, although the printing hue mode preset at the image forming apparatus is the color mode, then printing the existing received fax data is possible, although the fax data in the color mode is received. Accordingly, the controlling unit 170 requests the fax data in the mono mode to the transmitter through the PSTN interfacing unit 150 (S230). Afterwards, the operations of S230 through S260 are performed.

According to exemplary embodiments of the present invention, the image forming apparatus 100, which receives the fax data from the transmitter, requests the fax data from the transmitter according to the printing hue mode set by the user. Also, the image forming apparatus 100 then requests printable fax data from the transmitter in accordance with the usable developing agent in order to receive the printable fax data according to the state of the developing agents.

As described above, an image forming device having a fax function and a method for receiving fax data thereof, may allow a user to select the printing hue mode, that is, the mono mode or the color mode, so that reception failure or printing failure, due to absence of a developing agent of a particular color, can be prevented and waste of a developing agent caused by indiscriminately printing fax data in color mode can be saved.

In case of large data transmission, the fax data in the mono mode may be selected, which enables quicker transmission and reception than the fax data in the color mode.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image forming apparatus having a fax function, comprising:
a printing hue mode determining unit for determining a preset printing hue mode;
a developing agent determining unit for determining usability of a developing agent corresponding to the determined printing hue mode;
a public switched telephone network (PSTN) interfacing unit for performing interface with a transmitter through the PSTN;
a controlling unit for controlling the transmitter to transmit requested fax data in a preset mode through the PSTN interfacing unit; and
a printing unit for printing the fax data received through the PSTN interfacing unit.

2. The image forming apparatus of claim 1, wherein the developing agent determining unit determines whether the developing agent is in a usable state, if the developing agents of hues available in a color mode are usable when the determined printing hue mode is in the color mode, and determines whether the developing agent is in a usable state, if at least one of the developing agents of the hues is usable when the determined printing hue mode is a mono mode.

3. The image forming apparatus of claim 1, wherein the controlling unit controls the PSTN interfacing unit to request the fax data from the transmitter corresponding to the printing hue mode when the developing agent is in the usable state, and request the fax data from the transmitter in a mono mode when the developing agent is unusable.

4. The image forming apparatus of claim 3, wherein the controlling unit requests the fax data in the color mode when the printing hue mode is in the color mode, and requests the fax data in the mono mode when the printing hue mode is the mono mode.

5. The image forming apparatus of claim 1, wherein when the fax data received through the PSTN interfacing unit is in the mono mode, the printing unit uses a black developing agent to print the fax data.

6. The image forming apparatus of claim 1, wherein when the fax data received through PSTN interfacing unit is in the mono mode, the printing unit uses at least one of the developing agents of hues available in a color mode to print the fax data.

7. The image forming apparatus of claim 1, wherein when the fax data received through PSTN interfacing unit is in the mono mode, the printing unit mixes the developing agents of hues available in a color mode to print the fax data.

8. A method for receiving fax data of an image forming device having fax function, the method comprising:
determining a preset printing hue mode when a communication request is received from a transmitter;
determining usability of a developing agent corresponding to the determined printing hue mode;
requesting fax data in a preset mode from the transmitter according to availability of the determined developing agent;
receiving the fax data in the preset mode from the transmitter; and
printing the received fax data.

9. The method for receiving fax data of claim 8, wherein in the determining of the usability of the developing agent, a determination is made as to whether the developing agent is in a usable state, if the developing agents of hues available in a color mode are usable when the determined printing hue mode is the color mode, and a determination is made as to whether the developing agent is in a usable state, if at least one of the developing agents of the hues is usable when the determined printing hue mode is a mono mode.

10. The method for receiving fax data of claim 8, wherein in the requesting of the fax data in the preset mode, the fax data corresponding to the printing hue mode is requested from the transmitter when the developing agent is in the usable state, and the fax data in a mono mode is requested from the transmitter when the developing agent is unusable.

11. The method for receiving fax data of claim 10, wherein in the requesting of the fax data corresponding to the printing hue mode, the fax data in the color mode is requested when the printing hue mode is the color mode, and the fax data in the mono mode is requested when the printing hue mode is the mono mode.

12. The method for receiving fax data of claim 8, wherein in the printing of the fax data, when the received fax data is in the mono mode, a black developing agent is used to print the fax data.

13. The method for receiving fax data of claim 8, wherein in the printing of the fax data, when the received fax data is in the mono mode, at least one of the developing agents of hues available in a color mode is used to print the fax data.

14. The method for receiving fax data of claim 8, wherein in the printing of the fax data, when the received fax data is in the mono mode, the developing agents of hues available in a color mode are mixed to print the fax data.
